(19) United States
(12) Patent Application Publication
(10) Pub. No.: US 2022/0025672 A1
(43) Pub. Date: Jan. 27, 2022

(54) BASE FOR VERTICAL POSTS

(71) Applicant: Ex Nihilo, LLC dba Jumping Targets, Lehi, UT (US)

(72) Inventor: Jared Miller, Lehi, UT (US)

(73) Assignee: Ex Nihilo, LLC dba Jumping Targets, Lehi, UT (US)

(21) Appl. No.: 17/382,983

(22) Filed: Jul. 22, 2021

Related U.S. Application Data
(60) Provisional application No. 63/055,613, filed on Jul. 23, 2020.

(51) Int. Cl. E04H 12/22; F16B 2/06

(52) U.S. Cl. CPC E04H 12/2253; E04H 12/2238; F16B 2/065

(57) ABSTRACT

A post base device and system is provided. The post base device includes a first support base, a second support base, and one or more post brackets. The post brackets may include legs which attach to one of the first support base or the second support base. The post bracket may further include an opening which receives a post.

### BACKGROUND

### 1. Technical Field

This disclosure relates generally to base which supports two vertical posts which may support a sign, a target, a paper, or other informational messages.

### 2. Description of the Related Art

Posts are found in a variety of places and are used for a variety of purposes. For example, fence posts provide structure that supports slats in a fence. In buildings, posts support beams, or headers, that either span a distance over a non-weight bearing structure, such as a door or a window, or provide vertical support for a load bearing beam, installed to support a floor or roof above. Posts may also be used as structural support for overhanging, balconies, and other building features.

Posts come in a variety of sizes, for a variety of purposes, from a variety of materials. Fence posts, for example, may be installed in the ground and may be made of a metal or wood, depending on a type of fence. Sign posts may be metal or wood, for aesthetic reasons or for durability. Structural posts may be made from metal, wood, or laminated veneer lumber, to suit different applications. In construction applications, posts are usually sized standardly to be commonly used in differing applications. For example, the most common post in construction applications is known as a “2×4,” pronounced “two by four,” which is available at virtually any construction goods store in the United States. So called “dimensional lumber” refers to lumber that is commonly referred to by size instead of by a name or, rather, that the size of the lumber has become a name for that lumber. For example, various sizes of dimensional lumber are known as “two by sixes,” “two by eights,” and so on. Only complicating matters more, the lumber industry has reduced the physical size of dimensional lumber to obtain more individual pieces of lumber from a single tree. For example, a “two by four,” which, in the past referred to lumber that was two inches thick by four inches wide was cut exactly two inches thick and four inches wide. Today, the same “two by four” is 1.50 inches thick and 3.50 inches wide.

Dimensional lumber is often used as a sign post or used to convey a message, especially in when those messages are intended to be temporary. Wooden telephone and electric poles are frequently plastered with informational bills or messages conveying anything from political support for a particular candidate to a lost child or pet. On construction sites, signs are frequently made from dimensional lumber to warn visitors about hazards at the site, indicate a funding source for the construction, indicate the purpose of the construction, and a host of other information. Construction lumber is particularly suitable for this purpose because dimensional lumber is well suited for building placards or holding signs and is relatively inexpensive on a per board basis.

Unfortunately, signs placed on posts typically require some construction to build a permanent enough support to maintain a sign in a particular position. And, the less building that goes into a sign holder, the less likely the structure is to withstand the elements for any significant period of time. Further, when a post is used to hold a sign operating as a target, for example, a single two by four is typically inadequate to hold the sign in position for a substantial length of time. Also, when posts are used to support a target or a message, the duration of need for the target or a message is limited to a shooting practice session or to an amount of time needed to provide people who pass by with a particular message.

It is therefore one object of this disclosure provide a base which supports vertical posts. It is another object of this disclosure to provide a base which supports vertical posts which is collapsible and easily transportable. It is a further object of this disclosure to provide a post bracket which secures a post to the base.

### SUMMARY

A post base device and system is provided. The post base device includes a first support base, a second support base, and one or more post brackets. The post brackets may include legs which attach to one of the first support base or the second support base. The post bracket may further include an opening which receives a post.

### BRIEF DESCRIPTION OF DRAWINGS

The accompanying drawings illustrate several embodiments of a system and device for a post base. The illustrated embodiments are exemplary and do not limit the scope of the disclosure.

FIG. 1 illustrates a side view of corresponding base supports.

FIG. 2 illustrates a perspective view of a post base including post brackets.

FIG. 3 illustrates a perspective view of a post base including post brackets.

FIG. 4 illustrates a top view of a post base including post brackets.

FIG. 5 illustrates a perspective view of a post base including posts.

FIG. 6 illustrates a perspective view of a post bracket.

### DETAILED DESCRIPTION OF PREFERRED EMBODIMENTS

In the following description, for purposes of explanation and not limitation, specific techniques and embodiments are set forth, such as particular techniques and configurations, in order to provide a thorough understanding of the system and device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein.

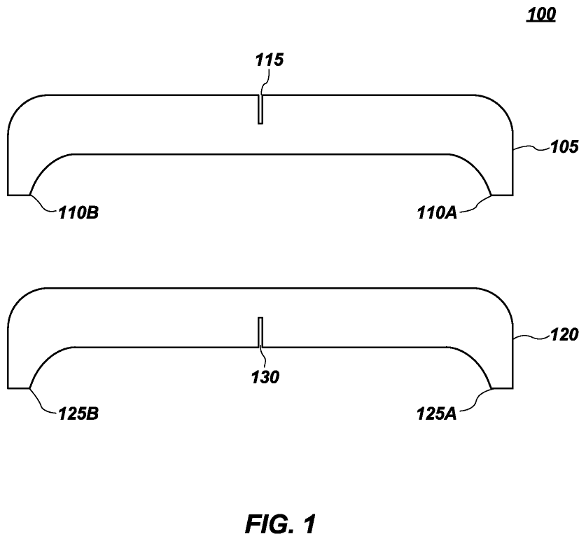

FIG. 1 illustrates a side view of corresponding base supports 100. Base supports 100 include a first base 105 and a second base 120. First base 105 includes a first foot 110A and a second foot 110B. First base 105 also includes a slot 115 disposed on a top side of base 105, which is a side of base 105 that is opposite to a side of base 105 which includes first foot 110A and second foot 110B. Second base 120 includes a third foot 125A and a fourth foot 125B. Second base further includes a slot 130 disposed on a bottom side of base 120, which is the same side of base 120 that includes third foot 125A and fourth foot 125B. Slot 130 of second base 120 may be installed into slot 115 of first base 105 to create a solid base for vertical posts, as will be discussed below. Typically, first base 105 and second base 120 may be constructed using hardened steel, such as AR-500 steel or other metals with a Brinell hardness value of 500 or greater. However, it is conceived that other metals may be used such as titanium, aluminum, iron, and other metal alloys.

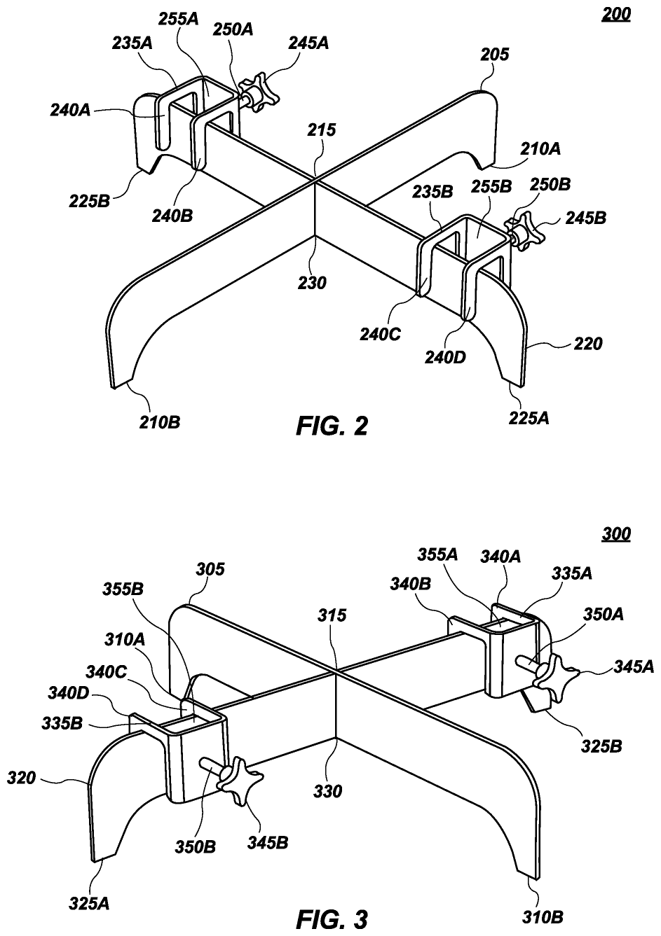

FIG. 2 illustrates a perspective view of a post base 200 including post brackets 235A and 235B. Post base 200 includes a first base 205 and a second base 220. First base 205 includes a first foot 210A and a second foot 210B. First base 205 also includes a slot 215 disposed on a top side of base 205, which is a side of base 205 that is opposite to a side of base 205 which includes first foot 210A and second foot 210B. Second base 220 includes a third foot 225A and a fourth foot 225B. Second base 220 further includes a slot 230 disposed on a bottom side of base 220, which is the same side of base 220 that includes third foot 225A and fourth foot 225B. As shown in FIG. 2, slot 230 of second base 220 is installed into slot 215 of first base 205 to create a solid base for vertical posts. First base 205 and second base 220 are interlocked by slot 215 and slot 230 being complimentary such that the slots are similarly sized and serve to lock first base 205 into second base 220 at approximately 90° angles from each other.

As shown in FIG. 2, post brackets 235A and 235B are disposed on second base 220. However, it should be noted that this is only exemplary and post brackets 235A and 235B may both be positioned on first base 205 or may, to facilitate some particular need, be each positioned on one of first base 205 or second base 220. Post bracket 235A and 235B are similar in their implementation. For example, post bracket 235A includes legs 240A and 240B which connect to, in the example of FIG. 2, second base 220 by extending over a top of second base 220 (the side opposite third foot 225A and 225B). Legs 240A and 240B extending over a top of second base 220 allows second base 220 to fit into a recess 255A which provides an opening to receive a post, as will be discussed below. Post bracket 235A may further include a shaft 250A disposed into a hole (shown in FIG. 6) which may be tapped, grooved, or otherwise arranged with shaft 250A to allow a user to increase or decrease pressure on a post within recess 255A. Shaft 250A may be a threaded bolt or a grooved shaft, or other device known in the art that provides a device to increase pressure on a post, for example, within recess 255A. Shaft 250A may further include a handle 245A which allows selective pressure to be applied to a post within recess 255A.

Post bracket 235A includes legs 240C and 240D which connect to, in the example of FIG. 2, second base 220 by extending over a top of second base 220 (the side opposite third foot 225A and 225B). Legs 240C and 240D extending over a top of second base 220 allows second base 220 to fit into a recess 255B which provides an opening to receive a post, as will be discussed below. Post bracket 235B may further include a shaft 250B disposed into a hole (shown in FIG. 6) which may be tapped, grooved, or otherwise arranged with shaft 250B to allow a user to increase or decrease pressure on a post within recess 255B. Shaft 250B may be a threaded bolt or a grooved steel shaft, or other device known in the art that provides a device to increase pressure on a post, for example, within recess 255B. Shaft 250B may further include a handle 245B which allows selective pressure to be applied to a post within recess 255B. As pressure is exerted on a post within recess 255A or 255B by shaft 250A/250B, respectively, the post is pressed against second base 220 which causes legs 240A-240D, respectively, to apply counter pressure to an opposing side of second base 220 (e.g., the side of second base 220 opposite of recess 255A (left/right or front/back sides)). In this manner, vertical posts may be secured in a solid manner to a solid and steady base. Base 200 and post brackets 235A/235B may be constructed using hardened steel, such as AR-500 steel or other metals with a Brinell hardness value of 500 or greater. However, it is conceived that other metals may be used such as titanium, aluminum, iron, and other metal alloys.

FIG. 3 illustrates a perspective view of a post base 300 include post brackets 335A and 335B. Post base 300 includes a first base 305 and a second base 320. First base 305 includes a first foot 310A and a second foot 310B. First base 305 also includes a slot 315 disposed on a top side of base 305, which is a side of base 305 that is opposite to a side of base 305 which includes first foot 310A and second foot 310B. Second base 320 includes a third foot 325A and a fourth foot 325B. Second base further includes a slot 330 disposed on a bottom side of base 320, which is the same side of base 320 that includes third foot 325A and fourth foot 325B. As shown in FIG. 3, slot 330 of second base 320 is installed into slot 315 of first base 305 to create a solid base for vertical posts. First base 305 and second base 320 are interlocked by slot 315 and slot 330 being complimentary such that the slots are similarly sized and serve to lock first base 305 into second base 320 at approximately 90° angles from each other.

As shown in FIG. 3, post brackets 335A and 335B are disposed on second base 320. However, it should be noted that this is only exemplary and post brackets 335A and 335B may both be positioned on first base 305 or may, to facilitate some particular need, be each positioned on one of first base 305 or second base 320. Post bracket 335A and 335B are similar in their implementation. For example, post bracket 335A includes legs 340A and 340B which connect to, in the example of FIG. 3, second base 320 by extending over a top of second base 320 (the side opposite third foot 325A and 325B). Legs 340A and 340B extending over a top of second base 320 allows second base 320 to fit into a recess 355A which provides an opening to receive a post, as will be discussed below. Post bracket 335A may further include a shaft 350A disposed into a hole (shown in FIG. 6) which may be tapped, grooved, or otherwise arranged with shaft 350A to allow a user to increase or decrease pressure on a post within recess 355A. Shaft 350A may be a threaded bolt or a grooved shaft, or other device known in the art that provides a device to increase pressure on a post, for example, within recess 355A. Shaft 350A may further include a handle 345A which allows selective pressure to be applied to a post within recess 355A.

Post bracket 335A includes legs 340C and 340D which connect to, in the example of FIG. 3, second base 320 by extending over a top of second base 320 (the side opposite third foot 325A and 325B). Legs 340C and 340D extending over a top of second base 320 allows second base 320 to fit into a recess 355B which provides an opening to receive a post, as will be discussed below. Post bracket 335B may further include a shaft 350B disposed into a hole (shown in FIG. 6) which may be tapped, grooved, or otherwise arranged with shaft 350B to allow a user to increase or decrease pressure on a post within recess 355B. Shaft 350B may be a threaded bolt or a grooved steel shaft, or other device known in the art that provides a device to increase pressure on a post, for example, within recess 355B. Shaft 350B may further include a handle 345B which allows selective pressure to be applied to a post within recess 355B. As pressure is exerted on a post within recess 355A or 355B by shaft 350A/350B, respectively, the post is pressed against second base 320 which causes legs 340A-340D, respectively, to apply counter pressure to an opposing side of second base 320 (e.g., the side of second base 320 opposite of recess 355A (left/right or front/back sides)). In this manner, vertical posts may be secured in a solid manner to a solid and steady base. Base 300 and post brackets 335A/335B may be constructed using hardened steel, such as AR-500 steel or other metals with a Brinell hardness value of 500 or greater. However, it is conceived that other metals may be used such as titanium, aluminum, iron, and other metal alloys.

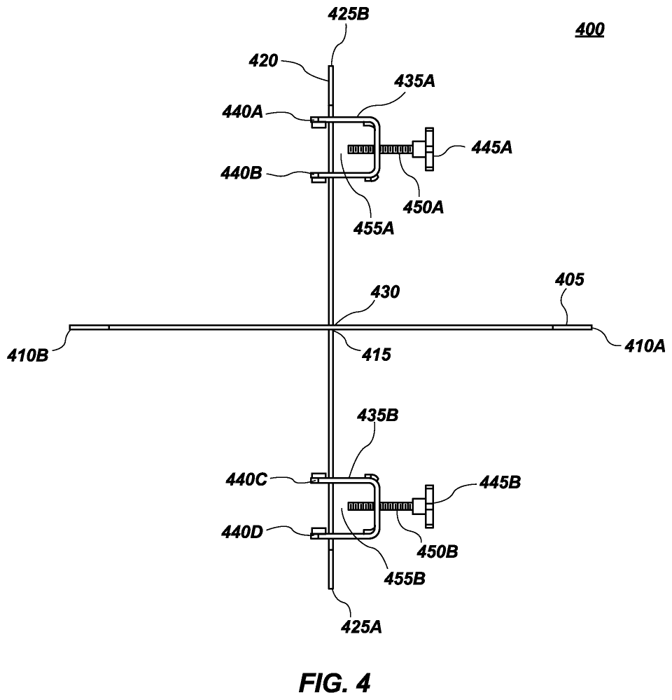

FIG. 4 illustrates a top view of a post base 400 including post brackets 435A/435B. Post base 400 includes a first base 405 and a second base 420. First base 405 includes a first foot 410A and a second foot 410B. First base 405 also includes a slot 415 disposed on a top side of base 405, which is a side of base 405 that is opposite to a side of base 405 which includes first foot 410A and second foot 410B. Second base 420 includes a third foot 425A and a fourth foot 425B. Second base further includes a slot 430 disposed on a bottom side of base 420, which is the same side of base 420 that includes third foot 425A and fourth foot 425B. As shown in FIG. 4, slot 430 of second base 420 is installed into slot 415 of first base 405 to create a solid base for vertical posts. First base 405 and second base 420 are interlocked by slot 415 and slot 430 being complimentary such that the slots are similarly sized and serve to lock first base 405 into second base 420 at approximately 90° angles from each other.

As shown in FIG. 4, post brackets 435A and 435B are disposed on second base 420. However, it should be noted that this is only exemplary and post brackets 435A and 435B may both be positioned on first base 405 or may, to facilitate some particular need, be each positioned on one of first base 405 or second base 420. Post bracket 435A and 435B are similar in their implementation. For example, post bracket 435A includes legs 440A and 440B which connect to, in the example of FIG. 4, second base 420 by extending over a top of second base 420 (the side opposite third foot 425A and 425B). Legs 440A and 440B extending over a top of second base 420 allows second base 420 to fit into a recess 455A which provides an opening to receive a post, as will be discussed below. Post bracket 435A may further include a shaft 450A disposed into a hole (shown in FIG. 6) which may be tapped, grooved, or otherwise arranged with shaft 450A to allow a user to increase or decrease pressure on a post within recess 455A. Shaft 450A may be a threaded bolt or a grooved shaft, or other device known in the art that provides a device to increase pressure on a post, for example, within recess 455A. Shaft 450A may further include a handle 445A which allows selective pressure to be applied to a post within recess 455A.

Post bracket 435A includes legs 440C and 440D which connect to, in the example of FIG. 4, second base 420 by extending over a top of second base 420 (the side opposite third foot 425A and 425B). Legs 440C and 440D extending over a top of second base 420 allows second base 420 to fit into a recess 455B which provides an opening to receive a post, as will be discussed below. Post bracket 435B may further include a shaft 450B disposed into a hole (shown in FIG. 6) which may be tapped, grooved, or otherwise arranged with shaft 450B to allow a user to increase or decrease pressure on a post within recess 455B. Shaft 450B may be a threaded bolt or a grooved steel shaft, or other device known in the art that provides a device to increase pressure on a post, for example, within recess 455B. Shaft 450B may further include a handle 445B which allows selective pressure to be applied to a post within recess 455B. As pressure is exerted on a post within recess 455A or 455B by shaft 450A/450B, respectively, the post is pressed against second base 420 which causes legs 440A-440D, respectively, to apply counter pressure to an opposing side of second base 420 (e.g., the side of second base 420 opposite of recess 455A (left/right or front/back sides)). In this manner, vertical posts may be secured in a solid manner to a solid and steady base. Base 400 and post brackets 435A/435B may be constructed using hardened steel, such as AR-500 steel or other metals with a Brinell hardness value of 500 or greater. However, it is conceived that other metals may be used such as titanium, aluminum, iron, and other metal alloys.

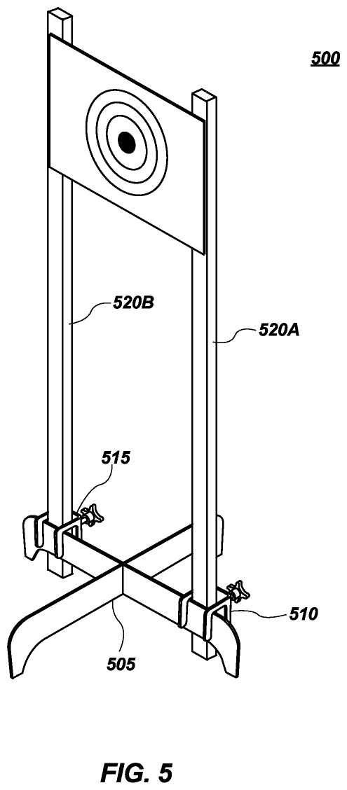

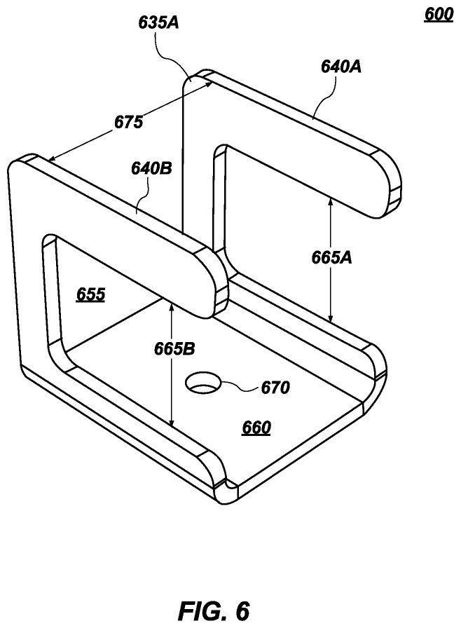

FIG. 5 illustrates a perspective view of a post base system 500 including posts 520A/520B. Post base 505 may be similar in implementation and description to post bases 200, 300, and 400 shown above with respect to FIGS. 2-4. Post base 505 may be fitted with one or more post brackets 510 and 515 which are similar in implementation and description to post brackets 235A/235B, 335A/335B, and 435A/435B, discussed in FIGS. 2-4, respectively. As shown in FIG. 5, posts 520A and 520B have been installed within post brackets 510 and 515, which are held in place by tension and pressure applied via post brackets 510 and 515 using the techniques described above—specifically, tightening a shaft against a post and post base 505 to hold the post upright. Post brackets 510 and 515 may be sized to accept dimensional lumber, such as a “2×4” and posts 520A/520B may be implemented as 2×4 lumber studs. Several advantages are provided by post base system 500. First, post base 505 is easily and quickly separated into its constituent components (e.g., first base 105 and first base 120 shown in FIG. 1). Second, the use of dimensional lumber as posts is convenient because dimensional lumber is ubiquitous and reasonably inexpensive. Third, two posts are effective for better holding signs, targets, and other informational messages because a sign, for example, may be attached on both sides to a post which prevents the sign from sagging as could happen with a single post. In one embodiment, post base 505 may be bullet resistant (e.g., resilient, and non-deforming against up to 50 caliber projectiles fired from a shoulder mounted firearm) and provide a target stand for paper targets. In another embodiment, post base 505 may be made from metal and allow a construction company to post a “No Trespassing” sign at the site of a new home build in a manner that reliably keeps the sign up while the construction crew is away from the construction site.

FIG. 6 illustrates a perspective view of a post bracket device 600. Post bracket device 600 may include a post bracket 635A and may be similar to post brackets 235A/235B, 335A/335B, 435A/435B, 510, and 515, shown in FIGS. 2-5. Post bracket 635A includes legs 640A and 640B which are similar to legs 240A/240B, 340A/340B, 440A/440B, shown in FIGS. 2-4. Post bracket 635 may further provide an opening 655, the depth and height of which is determined by corresponding recesses 665A and 665B in legs 640A and 640B, respectively. Post bracket 635A may further include a wall 660, which joins legs 640A and 640B and spaces legs 640A and 640B at an appropriate width 675 from each other to accept dimensional lumber. Post base 635A may further include a hole 670 which may be threaded, grooved, or otherwise treated to allow a user to increase pressure exerted on a post within opening 655, as described above.

The foregoing description is presented for purposes of illustration. It is not exhaustive and does not limit the invention to the precise forms or embodiments disclosed. Modifications and adaptations are apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A base, comprising
a first support base,
a second support base, and
one or more post brackets which include legs which attach to one of the first support base or the second support base and which include an opening to receive a post.

2. The base of claim 1 wherein the first support base and the second support base interlock.

3. The base of claim 1, wherein the one or more post brackets include a threaded hole.

4. The base of claim 3, wherein the one or more post brackets include a threaded shaft.

5. The base of claim 5, wherein the threaded shaft is a bolt.

6. The base of claim 6, wherein tightening the bolt decreases space within an opening of the one or more post brackets for the post.

7. The base of claim 1, wherein the legs of the one or more post brackets attach over the first base and include a threaded hole that receives a threaded shaft.

8. The base of claim 7, wherein as the threaded shaft is threaded through the threaded hole towards the base, pressure applied by the threaded shaft to a post in the hole is counteracted by the legs of the one or more post brackets.

9. The base of claim 1, wherein the first base includes a slot.

10. The base of claim 9, wherein the second base includes a slot.

11. The base of claim 10, wherein the slot of the first base and the slot of the second base interlock.

12. The base of claim 11, wherein the first base and the second base are disposed at 90 degrees to each other when interlocked.

13. The base of claim 1, wherein the first base includes a first foot and a second foot.

14. The base of claim 13, wherein the second base includes a third foot and a fourth foot.

15. The base of claim 14, wherein the first foot and the second foot are disposed on opposing ends of the first base.

16. The base of claim 15, wherein the third foot and the fourth foot are disposed on opposing ends of the second base.

17. The base of claim 1, wherein the one or more post brackets are sized to accept dimensional lumber.

18. The base of claim 1, wherein the one or more of the post brackets are disposed on the first contact base.

19. The base of claim 18, wherein one of the one or more of the post brackets are disposed on the first contact base between a slot and a first foot of the first contact base.

20. The base of claim 19, wherein one of the one or more of the post brackets are disposed on the first contact base between the slot and the second foot of the first contact base.
